(19) United States
(12) Patent Application Publication
(10) Pub. No.: US 2026/0253579 A1
(43) Pub. Date: Aug. 27, 2026

(54) MEASUREMENT OF PROSODY SIMILARITY USING A PROSODY ENCODER

(71) Applicant: Disney Enterprises, Inc., Burbank, CA (US)

(72) Inventors: Komath Naveen Kumar, Los Angeles, CA (US); Erika Doggett, Simi Valley, CA (US); SeYun UM, Seoul (KR)

(73) Assignee: Disney Enterprises, Inc., Burbank, CA (US)

(21) Appl. No.: 19/061,178

(22) Filed: Feb. 24, 2025

(51) Int. Cl. G10L 13/10; G10L 25/30; G10L 25/51

(52) U.S. Cl. CPC G10L 13/10; G10L 25/30; G10L 25/51

(57) ABSTRACT

In some embodiments, a method inputs a first speech sample into a prosody encoder, wherein the prosody encoder is trained as part of a text-to-speech model. A second speech sample is input into the prosody encoder. The prosody encoder generates a first representation of the first speech sample and a second representation of the second speech sample. The method compares the first representation and the second representation to determine a metric value and determines an action to perform based on the metric value.

### BACKGROUND

The determination of the similarity of speech samples may require a large amount of resources. Subjective comparison may be used where an expert listener may listen to the speech samples to subjectively determine similarity. However, the comparison may not be performed at scale. Other methods may be used to attempt to determine similarity. For example, speaker identity models may be used, which specialize in identifying the speaker. However, this is a narrow use case that only identifies the speaker.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 depicts a simplified system for comparing the prosody of speech samples according to some embodiments.

FIG. 2 depicts an example of a text-to-speech model according to some embodiments.

FIG. 3 depicts a simplified flowchart of a method for training the text-to-speech model according to some embodiments.

FIG. 4 depicts a simplified flowchart of a method for determining a similarity of speech samples according to some embodiments.

FIG. 5 depicts a system to perform the use cases according to some embodiments.

FIG. 6 illustrates one example of a computing device according to some embodiments.

### DETAILED DESCRIPTION

Described herein are techniques for a speech analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A text-to-speech (TTS) model may achieve high fidelity speech synthesis of text by encoding information about both a speaker's vocal identity and prosody. Prosody may be various aspects of the spoken language that convey a speaking style, which may be a meaning beyond the literal interpretation of individual words. Prosody may include the rhythm, stress, intonation patterns of speech, and other characteristics of speaking style. The text-to-speech models use reference audio recordings from a target speaker and extract additional information about desired target speech characteristics that might not be possible to infer from text alone. For example, the text-to-speech model may use a text encoder, a speaker encoder, and a prosody encoder. The text encoder may analyze text, such as a transcript. The speaker encoder may analyze speech of the target speaker. The prosody encoder may analyze speech of a target prosody. The text-to-speech model then generates speech based on the analysis of the text, speech, and prosody.

A system may train the text-to-speech model to adjust parameters of the text encoder, the speaker encoder, and the prosody encoder. The training may be performed by inputting text, speech of the target speaker, and speech of a target prosody into the text-to-speech model, which outputs speech of the target speaker with the target prosody. Then, the outputted speech may be analyzed and compared to a ground truth. A difference between the outputted speech and the ground truth may be used to adjust parameters of the text encoder, the speaker encoder, or the prosody encoder. This process continues with multiple samples until the text-to-speech model is trained.

Once the text-to-speech model is trained, the prosody encoder may be extracted and used to measure similarity between samples in terms of speaking style. For example, a first speech sample may be input into a prosody encoder and a second speech sample may be input into the prosody encoder. The prosody encoder may output prosody representations (e.g., embeddings) for the respective speech samples. The system may compare the prosody representations to determine a metric value. In some embodiments, the metric value may measure a similarity in prosody of the two speech samples. Other metrics may also be used to compare the prosody. Thereafter, the system may use the metric value to perform an action.

The system may provide many advantages. For example, the comparison may be performed automatically at scale without subjectivity among different reviewers. Further, the use of prosody representations may provide an improved similarity measurement. The space in which the prosody representations are encoded may be lower dimensional manifold than the space of the raw speech samples. The lower dimensional manifold may be a space with fewer degrees of freedom and a space potentially encoding a higher level concept such as speaking style or prosody. This means that while raw speech samples are described with a large, detailed set of features (high dimensionality), the prosody aspects are captured with a more condensed, essential set of parameters (lower dimensionality). This provides a representation of the speech samples and the prosody metric value may capture nuances of similarity while maintaining flexibility compared to the brittle representations of exact raw speech. Also, the training of the prosody encoder using the text-to-speech model may be an improved method of training the prosody encoder, which can generate prosody representations that are more accurate. For example, training a standalone prosody encoder may not be feasible since the task of directly predicting prosody from speech due to challenges related to quantifying or categorizing prosody into target labels to train the prosody encoder. Instead, by training a prosody encoder in the context of speech synthesis using the text-to-speech model, the prosody representation is required to capture a more detailed representation of speaking style to accurately synthesize speech (which is easier to quantify in evaluation and model loss functions). Additionally, when training a multi-speaker text-to-speech model, the prosody encoder also benefits from learning a representation that scales across unseen speakers. This has implications in terms of speech sample requirements for unseen speakers in test cases.

### System

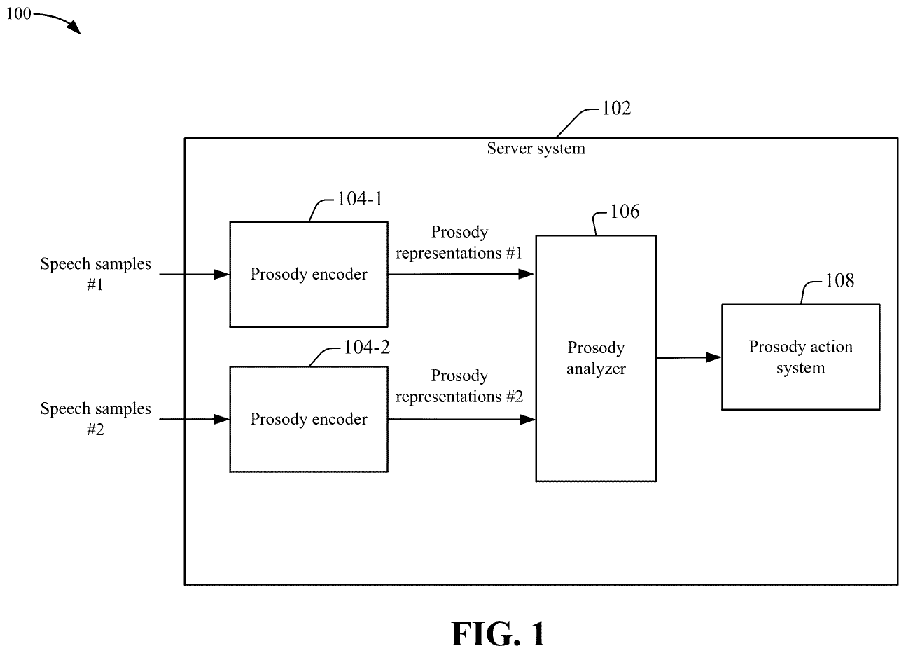

FIG. 1 depicts a simplified system 100 for comparing the prosody of speech samples according to some embodiments. System 100 includes a server system 102 that can analyze the prosody of speech samples. For example, server system 102 may include a prosody encoder 104-1 and a prosody encoder 104-2 (collectively prosody encoder 104). Although two instances of prosody encoder 104-1 and 104-2 are shown, prosody encoder 104 may be only a single instance of a prosody encoder. Multiple instances of prosody encoders may also be used to process speech samples in parallel, but the instances may have the same parameter settings. When prosody encoder 104 is described, the prosody encoder may be a single instance of a prosody encoder or multiple instances of the prosody encoder.

Prosody encoder 104-1 receives speech samples #1 and prosody encoder 104-2 receives speech samples #2. Prosody encoder 104-1 outputs prosody representations #1 and prosody encoder 104-2 outputs prosody representations #2. Respective prosody encoders 104-1 and 104-2 analyze the speech samples to generate prosody representations of the respective speech samples in a space. For example, the prosody representations may be referred to as embeddings in a different dimensional space, such as a lower dimensional manifold compared to the space of the raw speech samples. Prosody encoder 104 may analyze characteristics of prosody in the speech sample, such as pitch, duration, rhythm, intonation, etc., to extract features. The features may be represented by values in a representation, such as a vector, that describes the features. As will be discussed in more detail below, prosody encoder 104 may be trained as part of a text-to-speech model.

A prosody analyzer 106 may analyze prosody representations #1 and prosody representations #2. For example, prosody analyzer 106 measures a metric between prosody representations #1 and prosody representations #2. For example, for a pair of speech samples #1 and #2, a pair of prosody representations #1 and #2 are output. Then, prosody analyzer 106 analyzes prosody representation #1 and prosody representation #2 to determine a metric value. In some embodiments, the metric value may quantify the similarity between prosody representation #1 and prosody representation #2. For example, the distance between the two representations in the space may be determined. The metric may be measured using different methods, which will be described in more detail below.

The metric value may be output to a prosody action system 108. Prosody action system 108 may perform an action based on the metric value. For example, speech samples #1 may have a target prosody. Prosody action system 108 may want to select which of speech samples #2 have the most similarity in prosody to the target prosody. Prosody action system 108 may analyze multiple metric values for pairs of speech samples, and then select a speech sample #2 from the set of speech samples #2 that is most similar to the prosody of speech samples #1. In some embodiments, speech samples #2 may be generated by different entities, such as people or synthesis systems. Prosody action system 108 may determine which speech sample #2 is most similar to the prosody of speech samples #1. Prosody action system 108 may select which person or synthesis system can output speech samples that are the most similar to speech samples #1. This process will be described in more detail below and other actions may also be appreciated and will be described in more detail below.

The following will now describe the training of the text-to-speech model to adjust parameters of prosody encoder 104 and then describe the use of the trained prosody encoder to analyze the similarity of speech samples.

### Training of Prosody Encoder

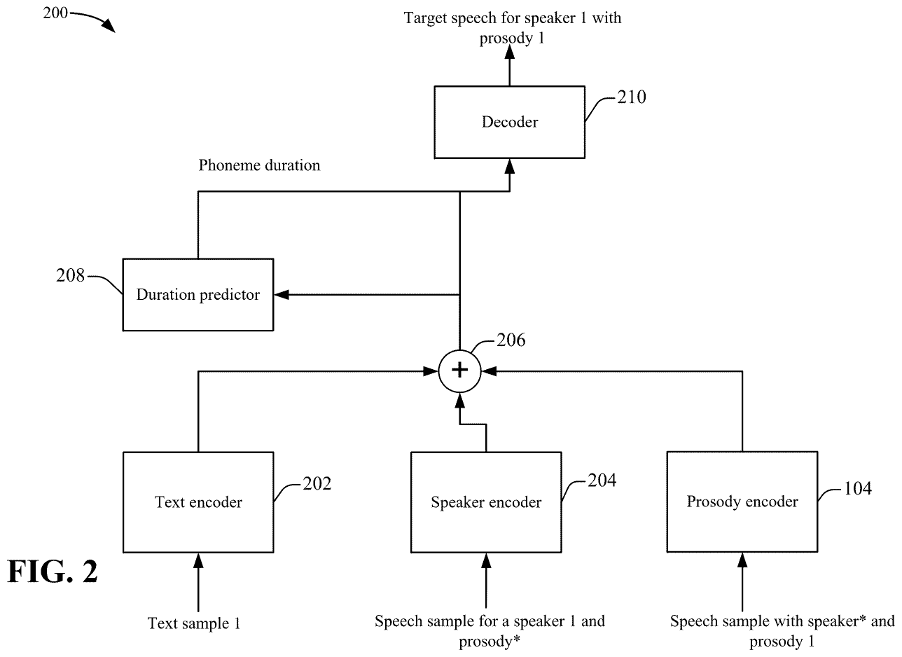

The operation of the text-to-speech model will be first described. Different text-to-speech models may be used and embodiments may use different structures that include a separate prosody encoder that receives speech samples as input. FIG. 2 depicts an example of a text-to-speech model 200 according to some embodiments. Text-to-speech model 200 converts text-to-speech. Text-to-speech model 200 includes a text encoder 202, a speaker encoder 204, and prosody encoder 104.

Text encoder 202 receives a text sample 1. The text sample 1 may be text of a desired target speech that will be output by text-to-speech model 200. Text encoder 202 may analyze the text of text sample 1 to generate a text representation in a space. The text representation may be an embedding that captures characteristics, such as linguistic and contextual information of the text. The text sample may be mapped to a vector representation in a different dimensional space compared to a space of the text sample. In some embodiments, text encoder 202 may first tokenize the text into tokens, and compute an embedding for each symbol in the text sequence according to a fixed vocabulary. After processing the text, it is represented as a sequence of discrete symbols from a fixed vocabulary, and dense embeddings that are learned in a continuous space for each symbol used to represent the text.

Speaker encoder 204 receives a speech sample for a speaker 1 with an arbitrary prosody represented with an asterisk (e.g., prosody*). The asterisk may be a wildcard where the speech sample may be of the target speaker 1, but does not have to be the target prosody 1 that is desired of the target speech. Speaker encoder 204 analyzes the speech sample to extract speaker specific characteristics to generate a speaker representation in a space. For example, the speaker representation may be an embedding (e.g., vector representation) in a different dimensional space compared to a space of the raw speech sample. The speaker representation may extract features of the characteristics of the speaker in the speech sample for speaker 1. The features may include voice timbre, tone, accents, energy, etc.

Prosody encoder 104 receives a speech sample from an arbitrary speaker represented with an asterisk (e.g., speaker*) with a prosody 1. The speech sample may be from any speaker, but the speech sample represents the target prosody 1 that is desired in the target speech. That is, this speech sample may have the desired speaking style of the target speech. Prosody encoder 104 may analyze the speech sample and output a prosody representation, which may be a prosody embedding that captures the characteristics of the prosody in the speech sample in a lower dimensional manifold. The prosody representation may extract features associated with characteristics of prosody, such as pitch, intonation, rhythm, etc. into a vector representation in the lower dimensional manifold.

Accordingly, the text embedding may encode features of linguistic and contextual information from the text sample 1, such as phonemes, syntax, and semantics. The speaker embedding may encode features of the speech sample for speaker 1, including timber, tone, etc. The prosody embedding may encode features of prosody, such as pitch, intonation, rhythm, etc.

At a combiner 206, text-to-speech model 200 combines the text embedding, the speaker embedding, and the prosody embedding. The combination may be performed differently. For example, the combination may concatenate the embeddings or add the embeddings element-wise. The combination may create a single representation that represents the text embedding, the speaker embedding, and the prosody embedding.

The single representation may be analyzed to generate the target speech for speaker 1 with the prosody 1. The single representation may include multiple phonemes. The phoneme may be a unit of sound in the target speech. Each phoneme may correspond to a specific speech sound. In some embodiments, the single representation may be input into a duration predictor 208, which may predict the duration of each phoneme. The phoneme duration is input into a decoder 210 along with the single representation. Decoder 210 analyzes the representation and the phoneme duration to output target speech for speaker 1 with prosody 1. Decoder 210 uses the phoneme representations and phoneme duration to generate speech. The output is target speech for speaker 1 with prosody 1. At the end of the text encoding stage, the length of the output sequence is proportional to the number of symbols in the text sequence. The duration predictor is used to scale up this length to match that of the audio sequence the text-to-speech model is trying to generate, which may be measured in number of sliding windows of an audio feature (e.g., a Mel Spectrogram). To train the duration predictor model, the text and speech sequences may be first aligned using an external acoustic model (force-alignment) or jointly aligned. As a result of this alignment, text-to-speech model 200 knows how many audio feature windows align with each text token, and the duration prediction model is trained to predict this value using a loss. At inference time, after a new text sequence is encoded (and after augmentation with speaker, prosody, or language embeddings), the expected durations for each text token are obtained using the pretrained duration predictor and rounded off to the nearest integer. The feature sequence is then expanded by passing through a length regulator that repeats the text embeddings the same number of times before passing through the decoder which predicts the audio features from the elongated sequence.

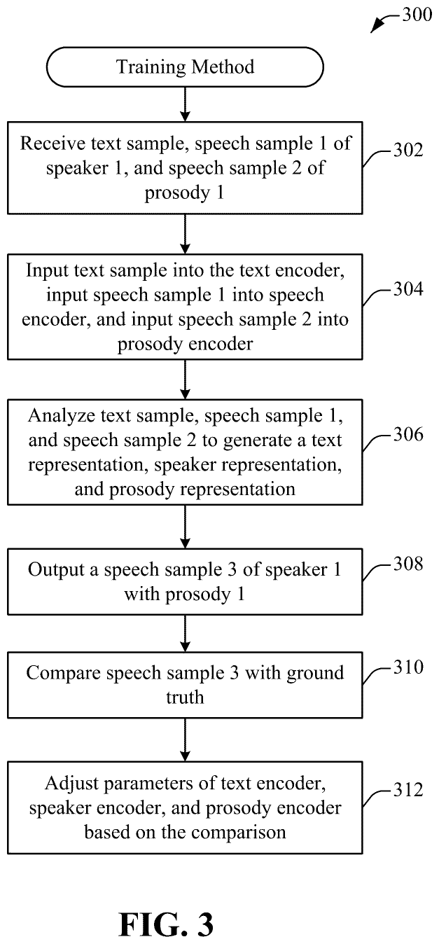

The parameters of text-to-speech model 200 may be trained. FIG. 3 depicts a simplified flowchart 300 of a method for training text-to-speech model 200 according to some embodiments. At 302, text-to-speech model 200 receives a text sample, a speech sample 1 of speaker 1, and a speech sample 2 of prosody 1. Speech sample 1 may be of an arbitrary prosody* and speech sample 2 may be from an arbitrary speaker*.

At 304, the text sample is input into text encoder 202, speech sample 1 is input into speaker encoder 204, and speech sample 2 is input into prosody encoder 104. In some embodiments, the text sample, speech sample 1, and speech sample 2 may be selected at random from a dataset that satisfies the conditions for text samples, speech samples 1, and speech samples 2. The dataset may include multiple speaker samples containing different speaker and prosody labels. The speaker labels may identify a speaker, and the prosody labels may identify the prosody.

At 306, text encoder 202 analyzes the text sample to generate a text representation, speaker encoder 204 analyzes speech sample 1 to generate a speaker representation, and prosody encoder 104 analyzes speech sample 2 to generate a prosody representation. The analysis may be performed based on the parameters of text encoder 202, speaker encoder 204, and prosody encoder 104.

Text-to-speech model 200 may further analyze the text representation, speaker representation, and prosody representation, such as described above in FIG. 2 using the combiner 206, duration predictor 208, and decoder 210. Then, at 308, text-to-speech model 200 outputs a speech sample 3 of speaker 1 with prosody 1. Speech sample 3 may be the predicted speech of the text for the target speaker 1 with the target prosody 1 that is determined by text-to-speech model 200.

At 310, speech sample 3 is compared with a ground truth. For example, the label of the speaker, the prosody, or both may be compared to the output of the speech sample 3 of speaker 1 and prosody 1. The comparison may calculate a difference between the outputted speech of speaker 1 with prosody 1 and the label of the speaker and prosody. An example of the labels to be compared to speech sample 3 may be the ground truth audio signal corresponding to text sample in the training dataset or audio features such as Mel Spectrogram derived from it. Different loss computations or comparisons may be used, such as mean square error (MSE) between the predicted speech sample 3 and ground truth audio might be measured and used to train text-to-speech model 200.

At 312, the parameters of text encoder 202, speaker encoder 204, and prosody encoder 104 may be adjusted based on the comparison. For example, the parameters may be adjusted to minimize the loss between the difference between the speech sample 3 and the labels.

The above process may continue until the loss is minimized. Although this method of training is described, other methods of training may be appreciated.

The training may adjust the parameters of modules in text-to-speech model 200 to optimize the output of text-to-speech model 200. This training may train the parameters of prosody encoder 104. Prosody encoder 104 is trained in the text-to-speech model 200 because the ground truth of the output of the text-to-speech model 200 is known while finding the ground truth of a prosody embedding may not be known.

After training, the parameters of prosody encoder 104 are set, prosody encoder 104 may be used to compare the similarity of prosody from two speech samples.

### Inference Process

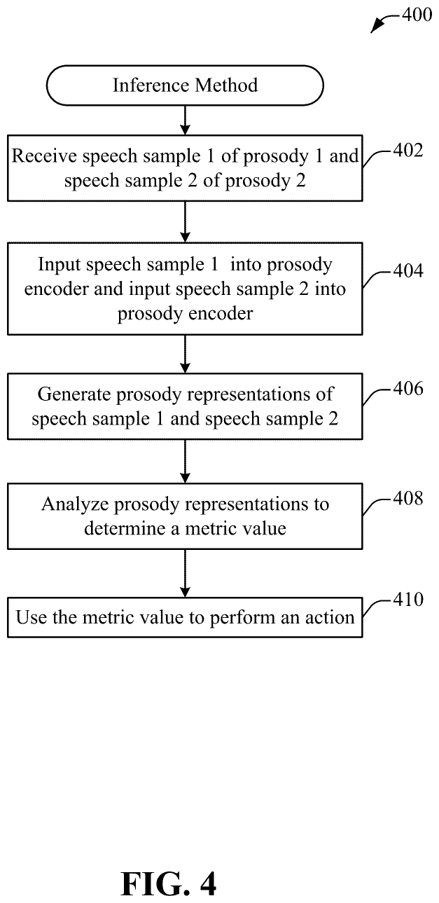

FIG. 4 depicts a simplified flowchart 400 of a method for determining a similarity of speech samples according to some embodiments. FIG. 4 may use the structure described in FIG. 1 to perform the inference process.

At 402, prosody encoder 104 receives a speech sample 1 of prosody 1 and a speech sample 2 of prosody 2. In some embodiments, speech sample 1 may be from a reference speaker with a target prosody and speech sample 2 may be of an arbitrary speaker with arbitrary prosody.

At 404, speech sample 1 is input into prosody encoder 104 and speech sample 2 is input into prosody encoder 104. A single prosody encoder may be used or multiple instances of prosody encoder 104 may be used. If multiple instances of prosody encoders 104 are used, the prosody encoders may have the same parameter values.

At 406, prosody encoder 104 generates prosody representations of speech sample 1 and speech sample 2. The prosody representations are generated using the parameters that were set during training. Here, prosody encoders 104 may be extracted from text-to-speech model 200 such that the prosody representations can be extracted from speech samples. Text-to-speech model 200 includes different modules, such as the prosody encoder 104, speaker encoder 204, text encoder 202, duration predictor 208, and decoder 210. Each of these modules include parameters or weights and biases for the underlying neural network architectures. Prosody encoder 104 can be extracted by isolating the parameters that are used in the prosody encoder network architecture, since they sufficiently define the input-output relationship the model. Then, a forward pass network for the prosody encoder 104 can be created by repeating all the operations corresponding to those parameters. Since the input to the prosody encoder 104 is audio, prosody encoder 104 can be used independent of any other modules in text-to-speech model 200.

At 408, prosody analyzer 106 analyzes the prosody representations to determine the metric value, which may measure similarity of prosody in the speech samples. For example, prosody analyzer 106 determines if speech sample 2 has a similar prosody to the target prosody of speech sample 1. The comparison of prosody representations may be determined using different processes. For example, Cosine similarity, Euclidean distance, Manhattan distance, Pearson correlation coefficient, or other similarity measurements may be used to determine a distance between the prosody representations. Then, prosody analyzer 106 may use a threshold to determine whether the prosody is similar or not. For example, if the metric value is within or meets a threshold (e.g., is less than), then prosody analyzer 106 determines the prosody is similar for speech sample 1 and speech sample 2. Other measurements may also be determined other than similarity.

At 410, prosody action system 108 uses the metric value to perform an action. Different examples of actions will now be described.

### Action Examples

In some embodiments, text-to-speech model 200 may be trained to generate speech for a Speaker B. Then, during an inference stage, an audio sample from another speaker with arbitrary prosody is input into prosody encoder 104 and a speech sample having a desired target prosody from Speaker B is input into prosody encoder 104. A sample B from Speaker B may be chosen at random or alternatively an average prosody for Speaker B may be used. This may be the reference or target prosody. A comparison of speech samples from a set A may then be performed. The comparison may use a Cosine similarity, Euclidean distance, Manhattan distance, Pearson correlation coefficient, or other similarity measurements.

In another example, a predetermined set of reference speech samples from a target speaker B can be used to fit in an anomaly detection algorithm that compares the prosody representations of a speech sample in a set A to identify whether the speech sample in set A belongs in the distribution or out of the distribution. Different anomaly detection metrics may be used. Also, given multiple samples from a set A, a prosody matching algorithm based on comparing distances between the two distributions may test a similarity between the distribution between set A and set B.

In another example, a large language model or other model may be trained to analyze prosody representations to determine a similarity between the prosody representations. In some embodiments, prosody encoder 104 may output prosody codes, which may be a series of codes that represent the prosody of the speech sample. The large language model analyzes the codes of two speech samples to determine a similarity metric. The codes may be like words that a large language model can process.

In one use case, audio samples for dubbing may be analyzed. In the problem of finding a suitable voice actor to dub lines for a speaker B in a different language, prosody encoders 104 may be used to select a voice performer or synthesis model that speaks in a similar prosody as speaker B. The intent of dubbing in a different language may be to retain the speaking style even if recorded in a different voice than speaker B. The system may be used to rank speech samples or flag a smaller subset for review. A feedback loop can also be set up using a trainable synthesis model that has its parameters tuned based on the comparison to output speech samples that are similar to the target prosody.

In another use case, the system may select a synthetic model from a series of synthetic synthesis models to mimic the prosody of speaker B. The synthesis models may use different network architectures, parameters, or be different trained models. In other embodiments, the system may be used to determine an optimal model by iteratively training a new model using the comparisons of metric values. The similarity may also be used to guide automatic speech recognition systems to better detect speech to translate into text. For example, the prosody may be checked in a speech sample, and then routed to a particular automated speech recognition system that may use the metric value to determine a dialect that uses the prosody.

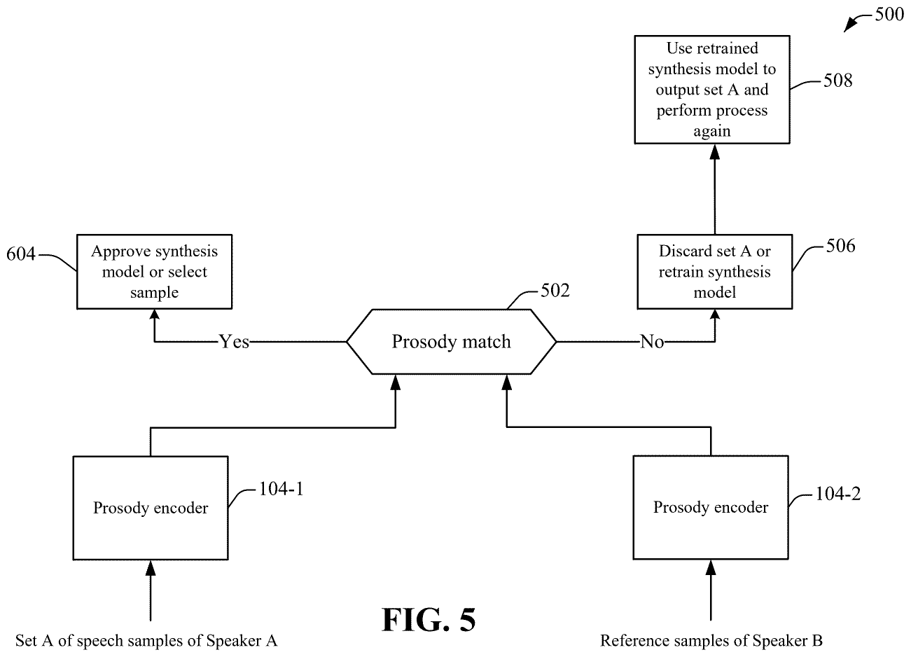

FIG. 5 depicts a system 500 to perform the use cases described above according to some embodiments. A set A of speech samples of a speaker A are input into prosody encoder 104-1. These speech samples may be from voice performers that are dubbing the lines of Speaker B or from synthesis models dubbing the lines from a speaker B. Reference samples of Speaker B are input into prosody encoder 104-2. The reference samples of Speaker B may have the target prosody that is desired.

At 502, prosody analyzer 106 analyzes prosody representations received from prosody encoders 104-1 and 104-2. Prosody analyzer 106 determines whether a prosody match is determined. For example, prosody analyzer 106 determines a metric value based on the two prosody representations. If the metric value meets a condition, such as is within a threshold, prosody analyzer 106 may determine a match. For example, a match may be determined if the distance is within a threshold. Other similarity measurements may be used as described above.

If a match is determined, at 604, depending on the use case, different actions may be performed. For example, in the audition use case, one or more samples may be selected as being similar. These samples may be reviewed to select one of the samples to use to dub the lines of speaker B. In the synthesis model evaluation, the synthesis model that provides the highest prosody match may be approved for use in synthesizing speech for speaker B.

If a match is not determined, at 506, set A may be discarded and another set A may be determined. Also, the synthesis model may be retrained to generate a new set A of speech samples. For example, parameters of the synthesis models may be adjusted based on the distance. At 508, the retrained synthesis models are used to output a new set A of speech samples, and the process is performed again. Also, a model may be trained to synthesize speech samples for the target prosody.

### Conclusion

Accordingly, many advantages are provided using the above system. For example, the text-to-speech model is leveraged to train a prosody encoder. This provides more accurate prosody representations. The use of the prosody representations may be able to capture small variations in speaking style that would not be possible using other metrics. The prosody representations may also be independent of speaker identity, which can capture similarity even when the same speaker is using different speaking styles. Further, the use of the prosody representations may be used to determine prosody similarity even when the speech samples are in different languages, such as in the case of dubbing where subjective analysis may be difficult due to the lack of references between two different languages. The prosody similarity that is required when dubbing languages may be relaxed to allow less similarity since the two speech samples may be in different languages and may not have the same exact prosody, but a similar relative prosody may be desired. The prosody representations may not rely on speaker specific characteristics and can be useful to identify categories such as accent and dialect groups. Additionally, the system may be able to analyze speech samples at scale without human subjectivity.

The system may be used to identify voice auditions that may be close to the target speaking style. This may be useful to select speech samples that may be similar in prosody to the target speech samples. Also, the dubbing scenario may use the system to select speech samples that match the prosody of the target speaker in another language. This may provide a dubbing that is more natural.

### System

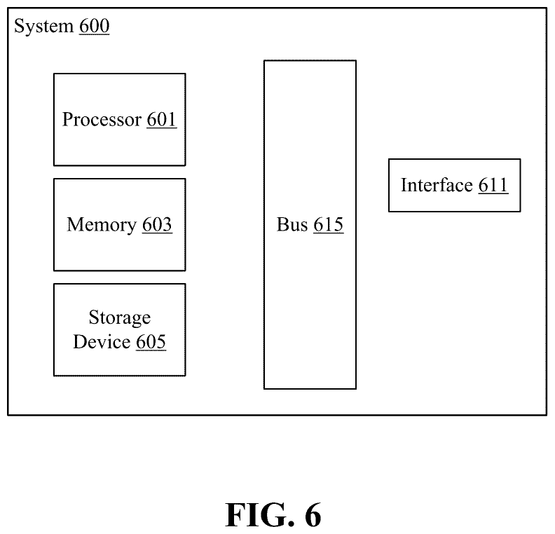

FIG. 6 illustrates one example of a computing device according to some embodiments. According to various embodiments, a system 600 suitable for implementing embodiments described herein includes a processor 601, a memory 603, a storage device 605, an interface 611, and a bus 615 (e.g., a PCI bus or other interconnection fabric.) System 600 may operate as a variety of devices such as server system 102, or any other device or service described herein. Although a particular configuration is described, a variety of alternative configurations are possible. Processor 601 may perform operations such as those described herein. Instructions for performing such operations may be embodied in memory 603, on one or more non-transitory computer readable media, or on some other storage device. Various specially configured devices can also be used in place of or in addition to processor 601. Memory 603 may be random access memory (RAM) or other dynamic storage devices. Storage device 605 may include a non-transitory computer-readable storage medium holding information, instructions, or some combination thereof, for example instructions that when executed by the processor 601, cause processor 601 to be configured or operable to perform one or more operations of a method as described herein. Bus 615 or other communication components may support communication of information within system 600. The interface 611 may be connected to bus 615 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
inputting a first speech sample into a prosody encoder, wherein the prosody encoder is trained as part of a text-to-speech model;
inputting a second speech sample into the prosody encoder;
generating, using the prosody encoder, a first representation of the first speech sample and a second representation of the second speech sample;
comparing the first representation and the second representation to determine a metric value; and
determining an action to perform based on the metric value.

2. The method of claim 1, further comprising:
training the prosody encoder based on an output of the text-to-speech model.

3. The method of claim 2, wherein training the prosody encoder comprises:
inputting a text sample into a text encoder of the text-to-speech model;
inputting a first speech sample into a speaker encoder of the text-to-speech model;
inputting a second speech sample into the prosody encoder of the text-to-speech model; and
generating the output of the text-to-speech model based on the text sample, the first speech sample, and the second speech sample.

4. The method of claim 3, wherein:
the first speech sample is based on a first speaker,
the second speech sample is based on a target prosody, and
the output of the text-to-speech model is speech for the first speaker with the target prosody.

5. The method of claim 4, wherein:
the first speech sample is of an arbitrary prosody; and
the second speech sample is of an arbitrary speaker.

6. The method of claim 4, wherein the text-to-speech model uses the text to determine the speech.

7. The method of claim 4, further comprising:
generating a first representation of the text sample using the text encoder;
generating a second representation of the first speech sample using the speaker encoder;
generating a third representation of the second speech sample using the prosody encoder; and
combining the first representation, the second representation, and the third representation to determine the output.

8. The method of claim 2, wherein training the prosody encoder comprises:
comparing the output of the text-to-speech model to a ground truth; and
adjusting a parameter of the prosody encoder based on the comparing.

9. The method of claim 2, further comprising:
after training the prosody encoder, extracting the prosody encoder from the text-to-speech model to generate the first representation and the second representation without generating the output of the text-to-speech model.

10. The method of claim 1, wherein:
the first speech sample is of a first prosody,
the second speech sample is of a second prosody,
the first representation is based on the first prosody, and
the second representation is based on the second prosody.

11. The method of claim 1, wherein comparing the first representation and the second representation comprises:
determining a similarity between the first representation and the second representation.

12. The method of claim 11, wherein the similarity is based on a distance between the first representation and the second representation.

13. The method of claim 11, wherein the similarity is based on whether the second representation is in a distribution associated with the first representation.

14. The method of claim 11, wherein:
the first representation and the second representation are input into a model; and
the model analyzes the first representation and the second representation to generate the metric value.

15. The method of claim 1, wherein:
the first speech sample is generated using a synthesis model,
the second speech sample is of a target prosody, and
the metric value is used to train the synthesis model to output speech with the target prosody.

16. The method of claim 1, wherein:
the first speech sample is generated using a synthesis model,
the second speech sample is of a target prosody, and
the metric value is used to select the synthesis model from multiple synthesis models to output speech with the target prosody.

17. The method of claim 1, wherein:
the first speech sample is generated in a different language from the second speech sample,
the second speech sample is of a target prosody, and
the metric value is used to select the first speech sample from multiple speech samples to output speech with the target prosody.

18. A non-transitory computer-readable storage medium having stored thereon computer executable instructions, which when executed by a computing device, cause the computing device to be operable for:
inputting a first speech sample into a prosody encoder, wherein the prosody encoder is trained as part of a text-to-speech model;
inputting a second speech sample into the prosody encoder;
generating, using the prosody encoder, a first representation of the first speech sample and a second representation of the second speech sample;
comparing the first representation and the second representation to determine a metric value; and
determining an action to perform based on the metric value.

19. The non-transitory computer-readable storage medium of claim 18, further operable for:
training the prosody encoder based on an output of the text-to-speech model, wherein training the prosody encoder comprises:
inputting a text sample into a text encoder of the text-to-speech model;
inputting a first speech sample into a speaker encoder of the text-to-speech model;
inputting a second speech sample into the prosody encoder of the text-to-speech model; and
generating the output of the text-to-speech model based on the text sample, the first speech sample, and the second speech sample.

20. An apparatus comprising:
one or more computer processors; and
a computer-readable storage medium comprising instructions for controlling the one or more computer processors to be operable for:
inputting a first speech sample into a prosody encoder, wherein the prosody encoder is trained as part of a text-to-speech model;
inputting a second speech sample into the prosody encoder;
generating, using the prosody encoder, a first representation of the first speech sample and a second representation of the second speech sample;
comparing the first representation and the second representation to determine a metric value; and
determining an action to perform based on the metric value.
